(19) United States
(12) Patent Application Publication
(10) Pub. No.: US 2025/0308819 A1
(43) Pub. Date: Oct. 2, 2025

(54) PROTECTION DEVICE

(71) Applicant: Polytronics Technology Corp., HSINCHU (TW)

(72) Inventors: TSUNG MIN SU, Hsinchu City (TW); CHIA MAO CHEN, Toufen City (TW); TONG CHENG TSAI, Taoyuan City (TW); YI-AN SHA, XINDIAN CITY (TW)

(21) Appl. No.: 18/767,427

(22) Filed: Jul. 9, 2024

(30) Foreign Application Priority Data
Apr. 2, 2024 (TW) 113112536

(51) Int. Cl. H01H 37/76; H01H 37/34; H01H 83/10

(52) U.S. Cl. CPC H01H 37/76; H01H 37/34; H01H 83/10; H01H 2037/768

(57) ABSTRACT

A protection device includes a meltable member, an electrode set, and a heating element. The meltable member has a core metal layer and a bottom metal layer disposed therebelow, and a melting point of the bottom metal layer is lower than that of the core metal layer. The electrode set has a first electrode, a second electrode, and an auxiliary electrode. The auxiliary electrode is located between the first electrode and the second electrode, and is disposed under the meltable member, thereby contacting the bottom metal layer. The meltable member has a hollow part penetrating the core metal layer, by which the bottom metal layer on the auxiliary electrode is exposed. The heating element is disposed under the auxiliary electrode, thereby heating up and blowing the meltable member in the event of over-voltage.

### BACKGROUND OF THE INVENTION

### (1) Field of the Invention

The present application relates to a protection device, and more specifically, to a fast-acting protection device.

### (2) Description of the Related Art

Fuses containing low melting point metals, such as, lead, tin or antimony, are well-known protection devices to cut off currents. To prevent over-current and over-voltage, various protection devices are continuously developed. For example, a device containing a substrate on which a heating layer and a low melting point metal layer are stacked in sequence. The heating layer heats up in the event of over-voltage, and then the heat is transferred upwards to the low melting point metal layer. As a result, the low melting point metal layer is melted and blown to sever currents flowing therethrough, so as to protect circuits or electronic apparatuses.

Recently, mobile apparatuses such as cellular phones and laptop computers are widely used, and people increasingly rely on such products over time. However, burnout or explosion of batteries of cellular phones or portable products during charging or discharging is often seen. Therefore, the manufacturers continuously improve the designs of over-current and over-voltage protection devices to prevent the batteries from being blown due to over-current or over-voltage during charging or discharging.

In a known protection device, a fuse containing a low melting point metal layer is in series connection to a power line of a battery, and the low melting point metal layer and a heating layer are electrically coupled to a switch and an integrated circuit (IC) device. When the IC device detects an over-voltage event, the IC device enables the switch to “on”. As a result, current flows through the heating layer to generate heat to melt and blow the low melting point metal layer, so as to sever the power line to the battery for over-voltage protection. Moreover, it can be easily understood that the fuse itself can be heated and blown by a large amount of current in the event of over-current, and therefore over-current protection can also be achieved.

Please refer to FIG. 1 and FIG. 2. FIG. 1 shows a top view of a known protection device 10, and FIG. 2 shows a cross-sectional view of the protection device along the line AA in FIG. 1. The major components of the protection device 10 include a meltable member 15, an electrode set, and a heating element 13. The meltable member 15 consists of a core metal layer 15b and at least one low-melting-point layer (e.g., a bottom metal layer 15a and a top low-melting-point layer 15c as shown in FIG. 2), and it can be quickly blown in the events of over-voltage, over-current, and/or over-temperature, thereby protecting the electronic apparatuses therefrom. The electrode set includes a first electrode 12a, a second electrode 12b, a third electrode 12c, a fourth electrode 12d, and an auxiliary electrode 12e. The first electrode 12a, the second electrode 12b, the third electrode 12c, and the fourth electrode 12d are printed on a substrate 11, and the auxiliary electrode 12e perpendicularly protrudes from the third electrode 12c and extends parallel to the substrate 11 and toward the right side in top view. The first electrode 12a and the second electrode 12b are electrically connected to an input terminal and an output terminal of a power supply. The meltable member 15 bridges the first electrode 12a and the second electrode 12b, thus being connected in series with the electronic apparatus to be protected (such as a battery). When the current or temperature becomes excessively large or high, the meltable member 15 is heated up and consequently blown. In addition, the blowing action can also be made by the heating element 13 positioned beneath the meltable member 15, thereby actively heating up and blowing the meltable member 15. The heating element 13 is disposed on the substrate 11, and is connected to the third electrode 12c and the fourth electrode 12d. An insulating layer 14 is disposed between the auxiliary electrode 12e and the heating element 13. The meltable member 15 and the heating element 13 are connected to a switch and a detecting unit (not shown). If the detecting unit detects an over-voltage event, the switch enables the heating element 13 to be electrically conductive. The current flows through the heating element 13 to generate heat to melt and blow the meltable member 15.

It is noted that in order to accelerate the blowing action of the meltable member 15, the at least one low-melting-point layer is additionally added. However, this introduces some issues in practical use, which are described in detail below. The aforementioned low-melting-point layer may be the bottom metal layer 15a. The bottom metal layer 15a is disposed under the core metal layer 15b and is connected to the first electrode 12a, the auxiliary electrode 12e, and the second electrode 12b. The auxiliary electrode 12e is disposed under the meltable member 15 and aligned with its center, which corresponds to the break point where the meltable member 15 blows and therefore a strict requirement for the covering area of the bottom metal layer 15a on the auxiliary electrode 12e is necessary. For instance, if the bottom metal layer 15a entirely covers the auxiliary electrode 12e beneath it, an excessive amount of the molten metal is often generated during the operation of the protection device 10. This may result in a partially blown meltable member 15 or increase the risk of reconnection of the molten metal at the break point, thereby elongating the blowing time. Moreover, since the formation of the bottom metal layer 15a is usually made by printing, it is difficult to precisely control its covering area or amount. Accordingly, there is still room for improvement in the protection devices.

### SUMMARY OF THE INVENTION

The present invention provides a protection device including a meltable member, an electrode set, and a heating element. The meltable member has a core metal layer and a bottom metal layer disposed below the core metal layer. The electrode set has a first electrode, a second electrode, and an auxiliary electrode. Two terminals of the meltable member are respectively connected to the first electrode and the second electrode, and the auxiliary electrode is disposed under the center of the meltable member, thereby contacting the bottom metal layer. The present invention deliberately removes a portion of the meltable member right above the auxiliary electrode, thereby creating a hollow part. The hollow part penetrates the core metal layer and exposes the bottom metal layer, while the top-view area of the hollow part and the top-view area of the bottom metal layer can be adjusted independently of each other to some extent. In other words, on the auxiliary electrode, the hollow part enables independent adjustment of the top-view area of the core metal layer (e.g., “connecting area” as described in the following context) and the covering area of the bottom metal layer, thereby accelerating the blowing action of the protection device during operation.

In accordance with an aspect of the present invention, a protection device includes a meltable member, an electrode set, and a heating element. The meltable member has a core metal layer and a bottom metal layer disposed below the core metal layer. A melting point of the bottom metal layer is lower than a melting point of the core metal layer. The electrode set has a first electrode, a second electrode, and an auxiliary electrode. Two terminals of the meltable member are respectively connected to the first electrode and the second electrode. The auxiliary electrode is located between the first electrode and the second electrode, and is disposed under the meltable member, thereby contacting the bottom metal layer. The meltable member has a hollow part penetrating the core metal layer, by which the bottom metal layer on the auxiliary electrode is exposed. The heating element is disposed under the auxiliary electrode, thereby heating up and blowing the meltable member during an over-voltage event.

In an embodiment, an overlap region between the core metal layer and the auxiliary electrode has a connecting area in top view. The hollow part has a first top-view area in top view. If the sum of the connecting area and the first top-view area is calculated as 100%, the connecting area ranges from 10% to 83%.

In an embodiment, the hollow part completely overlaps the auxiliary electrode in top view.

In an embodiment, the bottom metal layer on the auxiliary electrode has a second top-view area in top view. If the sum of the connecting area and the first top-view area is calculated as 100%, the second top-view area ranges from 50% to 90%.

In an embodiment, the meltable member extends from the first electrode to the second electrode along a first direction, and has a first length parallel to the first direction and a first width parallel to a second direction, wherein the first direction is perpendicular to the second direction. The auxiliary electrode has an electrode width parallel to the first direction, and extends from one side to the other side of the meltable member along the second direction in top view, by which the meltable member intersects the auxiliary electrode and an overlap region is formed therebetween. The hollow part is located in the overlap region, and has a second length parallel to the second direction and a second width parallel to the first direction. A ratio of the second length of the hollow part divided by the first width of the meltable member is less than 0.9, and the second width of the hollow part is shorter than the electrode width of the auxiliary electrode.

In an embodiment, the hollow part has a square shape, a cross shape, or a diamond shape in top view.

In an embodiment, the bottom metal layer on the auxiliary electrode is divided into a plurality of sections in top view.

In an embodiment, a shortest distance between any two adjacent sections is at least 0.1 mm.

In an embodiment, the core metal layer has a thickness ranging from 0.01 mm to 0.3 mm.

In an embodiment, the bottom metal layer has a thickness ranging from 0.1 mm to 1 mm.

In an embodiment, the core metal layer consists of a single layer, wherein the core metal layer is made of tin-silver-lead alloy, tin-silver-copper alloy, tin-silver-bismuth alloy, or tin-zinc alloy.

In an embodiment, the core metal layer consists of a plurality of metal layers, wherein the core metal layer is a three-layer structure by sequentially stacking a tin layer, a silver layer, and a tin layer, or by sequentially stacking a silver layer, a tin layer, and a silver layer.

In an embodiment, the core metal layer consists of a plurality of metal layers, wherein the core metal layer is a five-layer structure by sequentially stacking a silver layer, a tin layer, a silver layer, a tin layer, and a silver layer, or by sequentially stacking a tin layer, a silver layer, a tin layer, a silver layer, and a tin layer.

In an embodiment, the bottom metal layer includes tin, tin-silver-copper alloy, tin-silver-lead alloy, tin-bismuth alloy, or combinations thereof.

In an embodiment, the heating element includes ruthenium oxide, nickel-chromium alloy, lead-germanium alloy, silicon-germanium alloy, or combinations thereof.

In an embodiment, the protection device further includes a substrate and an insulating layer. The heating element is disposed on the substrate. The insulating layer is disposed between the auxiliary electrode and the heating element, and extends to the substrate.

In an embodiment, the insulating layer includes a glass, a glass-ceramic material, aluminum oxide, silicon carbide, magnesium silicon nitride, or combinations thereof.

In accordance with an aspect of the present invention, a protection device includes a meltable member, an electrode set, and a heating element. The meltable member has a core metal layer and a bottom metal layer disposed below the core metal layer. A melting point of the bottom metal layer is lower than a melting point of the core metal layer. The electrode set has a first electrode, a second electrode, and an auxiliary electrode. Two terminals of the meltable member are respectively connected to the first electrode and the second electrode. The auxiliary electrode is located between the first electrode and the second electrode, and is disposed under the meltable member, thereby contacting the bottom metal layer. An overlap region is formed between the core metal layer and the auxiliary electrode in top view, and the core metal layer is devoid of any hollow part in the overlap region. A top-view area of the bottom metal layer on the auxiliary electrode is smaller than a top-view area of the overlap region. The heating element is disposed under the auxiliary electrode, thereby heating up and blowing the meltable member during an over-voltage event.

In an embodiment, if the top-view area of the overlap region is calculated as 100%, the top-view area of the bottom metal layer on the auxiliary electrode ranges from 30% to 79%.

In an embodiment, the bottom metal layer on the auxiliary electrode is divided into a plurality of sections in top view.

In an embodiment, the plurality of sections of the bottom metal layer consists of a first section and a second section, and the meltable member has a first long side and a second long side opposite to the first long side in top view, wherein the first section and the second section extend from the first long side to the second long side, and a shortest distance between the first section and the second section is at least 0.1 mm.

In an embodiment, the meltable member has a first long side and a second long side opposite to the first long side, and the bottom metal layer discontinuously extends from the first long side to the second long side, thereby forming a first section, a second section, and a third section of the plurality of sections, wherein the first section overlaps the first long side, the third section overlaps the second long side, and the second section is located between the first section and the third section, wherein a shortest distance between any two adjacent sections is at least 0.1 mm.

In an embodiment, the plurality of sections of the bottom metal layer consists of a first section, a second section, a third section, and a fourth section, wherein the meltable member has a first long side and a second long side opposite to the first long side in top view, wherein the plurality of sections do not overlap the first long side and the second long side, and the plurality of sections do not extend to any edge of the auxiliary electrode, wherein a shortest distance between any two adjacent sections is at least 0.1 mm.

### BRIEF DESCRIPTION OF THE DRAWINGS

The present application will be described according to the appended drawings in which:

FIG. 1 shows a top view of a protection device;

FIG. 2 shows a cross-sectional view of the protection device along the line AA depicted in FIG. 1;

FIG. 3 shows a top view of a protection device of the present invention;

FIG. 4 shows a cross-sectional view of the protection device along the line AA depicted in FIG. 3;

FIG. 5a shows a top view of a protection device of the present invention;

FIG. 5b shows an embodiment of the protection device in FIG. 5a; and

FIG. 6 to FIG. 10 show various embodiments of the protection device in FIG. 3.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

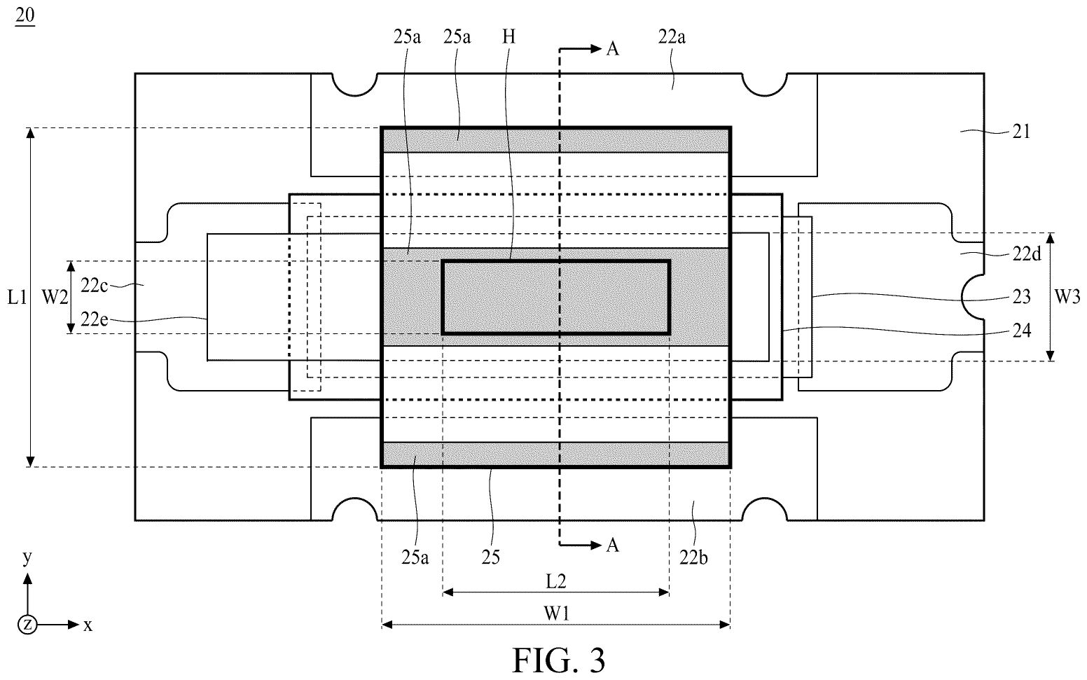

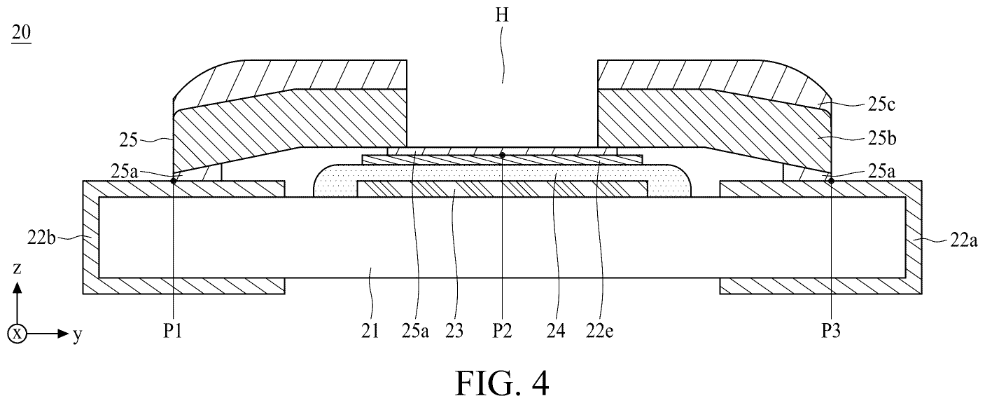

Please refer to FIG. 3 and FIG. 4. FIG. 3 shows a top view of a protection device 20 of the present invention. FIG. 4 shows a cross-sectional view of the protection device 20 along the line AA depicted in FIG. 3. The major components of the protection device 20 include a meltable member 25, an electrode set, and a heating element 23. The meltable member 25 includes a core metal layer 25b and at least one low-melting-point layer, and it can be quickly blown in the events of over-voltage, over-current, and/or over-temperature, thereby protecting the electronic apparatus therefrom. The core metal layer 25b may consist of a single layer or a plurality of layers. In one embodiment, the core metal layer 25b consists of a single layer, which is made of tin-silver-lead alloy, tin-silver-copper alloy, tin-silver-bismuth alloy, or tin-zinc alloy. In one embodiment, the core metal layer 25b is a three-layer structure by sequentially stacking a tin layer, a silver layer, and a tin layer, or by sequentially stacking a silver layer, a tin layer, and a silver layer. In another embodiment, the core metal layer 25b is a five-layer structure by sequentially stacking a silver layer, a tin layer, a silver layer, a tin layer, and a silver layer, or by sequentially stacking a tin layer, a silver layer, a tin layer, a silver layer, and a tin layer. The electrode set includes a first electrode 22a, a second electrode 22b, a third electrode 22c, a fourth electrode 22d, and an auxiliary electrode 22e. The first electrode 22a, the second electrode 22b, the third electrode 22c, and the fourth electrode 22d are printed on a substrate 21. The auxiliary electrode 22e perpendicularly protrudes from the third electrode 22c along the z-axis, and extends parallel to the substrate 21 along the x-axis and toward the right side in top view. The first electrode 22a is electrically connected to an input terminal, and the second electrode 22b is electrically connected to an output terminal of a power supply. The meltable member 25 is not attached to the substrate 21 and bridges the first electrode 22a and the second electrode 22b, thus being connected in series with the electronic apparatus to be protected (such as a battery). When the current or temperature becomes excessively large or high, the meltable member 25 is heated up and consequently blown, thereby preventing the battery from exploding during the charge or discharge process. To further enhance the blowing efficiency of the meltable member 25, the heating element 23 is disposed below and actively blows the meltable member 25. More specifically, the heating element 23 is disposed on the substrate 21, and is connected to the third electrode 22c and the fourth electrode 22d. The meltable member 25 and the heating element 23 are connected to a switch and a detecting unit (not shown). If the detecting unit detects an over-voltage event, the switch enables the heating element 23 to be electrically conductive. The current flows through the heating element 23 to generate heat to melt and blow the meltable member 25. The heating element 23 includes ruthenium oxide, nickel-chromium alloy, lead-germanium alloy, silicon-germanium alloy, or combinations thereof. In addition, the auxiliary electrode 22e physically contacts the meltable member 25, facilitating the transfer of heat generated by the heating element 23 and adsorbing the molten part of the meltable member 25. An insulating layer 24 is further included between the auxiliary electrode 22e and the heating element 23. The insulating layer 24 covers the heating element 23, and extends beyond the heating element 23 in directions (along the y-axis) toward both the first electrode 22a and the second electrode 22b to attach to the substrate 21. The insulating layer 24 includes a glass, a glass-ceramic material, aluminum oxide, silicon carbide, magnesium silicon nitride, or combinations thereof. In FIG. 3, it is understood that the solid line is used to illustrate the exposed portion as viewed from the top, while the dashed line is used to illustrate the covered portion as viewed from the top. Accordingly, for the central portion in this top view, the protection device 20 includes the meltable member 25, the auxiliary electrode 22e, the insulating layer 24, and the heating element 23, stacked from top to bottom.

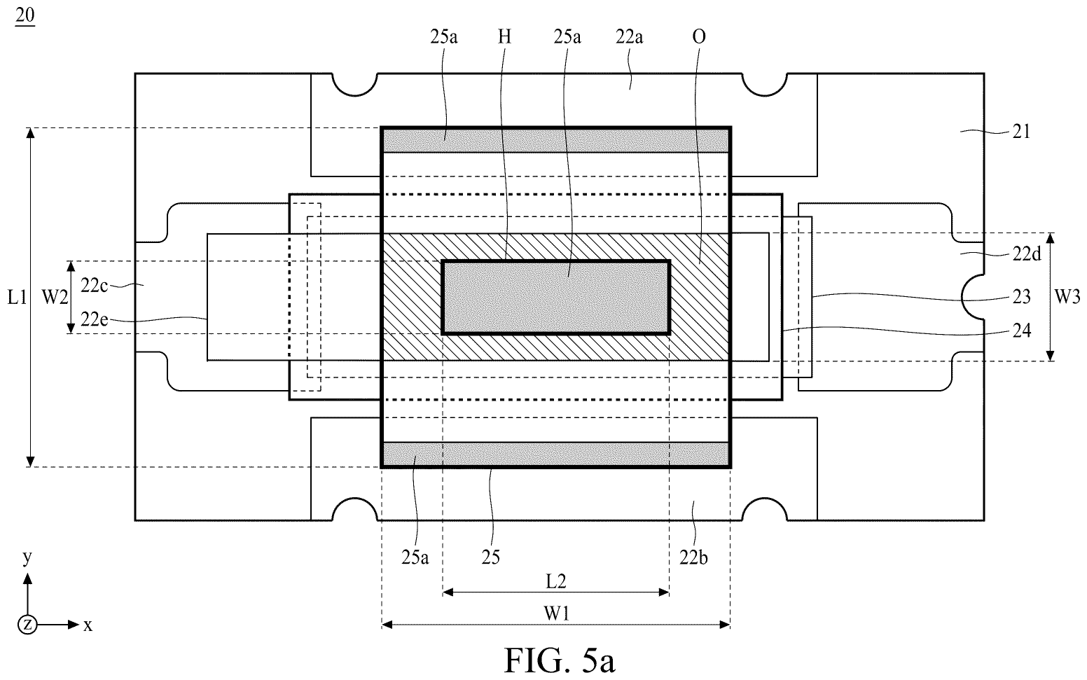

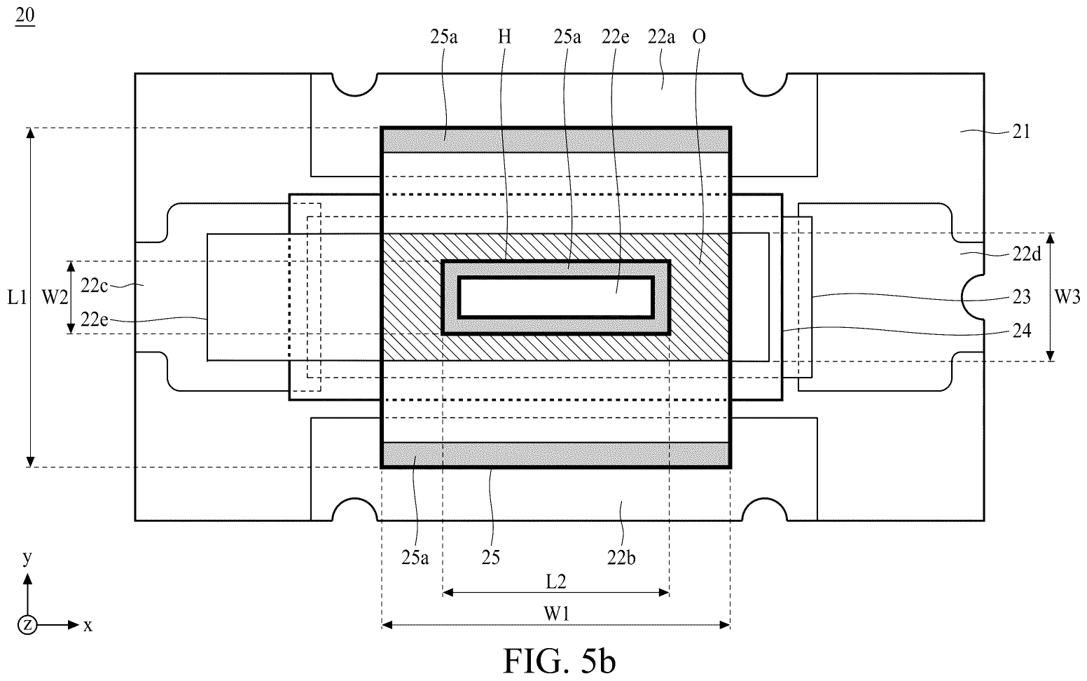

It is noted that a part of the meltable member 25, located right above the auxiliary electrode 22e, can be partially removed by a laser drilling or stamping process, thereby forming a hollow part H. The hollow part H is aligned with the center of the meltable member 25, and completely overlaps the auxiliary electrode 22e in top view (i.e., its edges are not aligned with the edges of the auxiliary electrode 22e and its profile is completely inside the profile of the auxiliary electrode 22e), exposing a bottom metal layer 25a on the auxiliary electrode 22e. The bottom metal layer 25a includes tin, tin-silver-copper alloy, tin-silver-lead alloy, tin-bismuth alloy, or combinations thereof. From the top view, the connecting area O of the core metal layer 25b and the top-view area of the bottom metal layer 25a on the auxiliary electrode 22e can be adjusted independently of each other (further details will be provided in the following context, accompanied by FIG. 5a and FIG. 5b). It is understood that the bottom metal layer 25a is located at the bottom of the meltable member 25, and should theoretically be covered and not visible when viewed from the top. However, in order to clearly illustrate the distribution area of the bottom metal layer 25a, it is depicted in solid blocks. As shown in FIG. 3, the bottom metal layer 25a may be optionally disposed on the two terminals of the meltable member 25 (corresponding to the first electrode 22a and the second electrode 22b) in addition to its center (corresponding to the auxiliary electrode 22e).

To clearly describe the structural design of the meltable member 25, please continue to refer to FIG. 4. FIG. 4 shows a cross-sectional view of the protection device 20 along the line AA depicted in FIG. 3. The protection device 20 includes the meltable member 25, the electrode set, and the heating element 23. Besides the core metal layer 25b and the bottom metal layer 25a as previously mentioned, the meltable member 25 may optionally include a top low-melting-point layer 25c on its top. The top low-melting-point layer 25c includes a rosin resin, a surfactant, a thickening agent, and/or a solvent. The bottom metal layer 25a is disposed below the core metal layer 25b, while the top low-melting-point layer 25c is disposed above the core metal layer 25b. The melting points of the bottom metal layer 25a and the top low-melting-point layer 25c are below the melting point of the core metal layer 25b. A eutectic alloy can be formed between the bottom metal layer 25a and the core metal layer 25b under high temperature. The eutectic alloy has a melting point lower than that of the core metal layer 25b, thereby accelerating the blowing action of the meltable member 25. From the cross-sectional view, the electrode set has the first electrode 22a, the second electrode 22b, and the auxiliary electrode 22e. Two terminals of the meltable member 25 are respectively connected to the first electrode 22a and the second electrode 22b. The auxiliary electrode 22e is located between the first electrode 22a and the second electrode 22b, and is disposed under the meltable member 25, thereby contacting the bottom metal layer 25a. The meltable member 25 has the hollow part H penetrating the top low-melting-point layer 25c and the core metal layer 25b, by which the bottom metal layer 25a on the auxiliary electrode 22e is exposed. The heating element 23 is disposed under the auxiliary electrode 22e, thereby heating up and blowing the meltable member 25 during an over-voltage event. In addition, the insulating layer 24 is disposed between the auxiliary electrode 22e and the heating element 24. From the cross-sectional view, the insulating layer 24 entirely covers the heating element 23 and extends further to attach to the substrate 21, and is substantially disposed below the center of the bottom metal layer 25a. The bottom metal layer 25a is not in physical contact with the insulating layer 24, and hence there is a gap between the bottom metal layer 25a and the insulating layer 24. The insulating layer 24 exhibits better thermal conductivity than ambient air. Consequently, the heat generated by the heating element 23 can be more concentrated and directly transferred upwards to the bottom metal layer 25a, accelerating the blowing action. To further accelerate the blowing action, the distribution of the bottom metal layer 25a may also include the positions corresponding to the first electrode 22a and the second electrode 22b. Three points of location are illustrated on the meltable member 25. The leftmost one is a first terminal point P1; the middle one is a middle point P2; and the rightmost one is a second terminal point P3. The bottom metal layer 25a of the meltable member 25 discontinuously extends from the first terminal point P1 to the second terminal point P3 along the y-axis. Therefore, the bottom metal layer 25a is divided into at least three parts, independently disposed on the second electrode 22b, the auxiliary electrode 22e, and the first electrode 22a.

Please refer to the FIG. 3 and FIG. 5a. The present invention accurately controls the connecting area O between the core metal layer 25b and the auxiliary electrode 22e, as well as the covering area of the bottom metal layer 25a on the auxiliary electrode 22e, thereby accelerating the blowing action of the meltable member 25. The details are described below.

The overlap region between the core metal layer 25b and the auxiliary electrode 22e forms the connecting area O when viewed from the top, while the hollow part H has a first top-view area. More specifically, after penetration, the remaining part of the core metal layer overlaps the auxiliary electrode 22e, thereby constituting the region where the core metal layer 25b connects to the auxiliary electrode 22e and having the connecting area O (i.e., illustrated in slash lines in FIG. 5b); and an image of the removed part (i.e., the hollow part H) of the core metal layer 25b can be projected onto the bottom metal layer 25a, and the projected area substantially corresponds to the first top-view area as previously mentioned. In other words, the sum of the connecting area O and the first top-view area is the overlap area between the intact core metal layer and the auxiliary electrode 22e before penetration. In the present invention, if the sum of the connecting area O and the first top-view area is calculated as 100%, the connecting area O ranges from 10% to 83%. Compared to the intact core metal layer, the core metal layer 25b of the present invention has a smaller mass. Under a fixed amount of heat to be absorbed, the change in temperature is inversely proportional to the mass. The smaller mass results in a faster temperature increase, allowing the core metal layer 25b to heat up more quickly and therefore blow faster. Moreover, the transverse length along the x-axis of the core metal layer 25b is greatly shortened. This means that the linear distance to be melted is extremely short, which accelerates the blowing time. Additionally, the hollow part H also provides space available for structural deformation, preventing excessive deformation of the meltable member 25 due to high temperature during assembly. This increases the yield rate of the device. It is noted that the percentage of the connecting area O needs to be controlled in the aforementioned range based on the hollow part H. If the connecting area O exceeds 83%, there is no significant improvement in the blowing time and the yield rate of the protection device 20, thus adding a burden to the manufacturing process. If the connecting area O is less than 10%, the core metal layer 25b on the auxiliary electrode 22e is excessively removed and can easily crack or fracture during subsequent assembly. In one embodiment, the connecting area O may vary within the range from 10% to 78%, from 15% to 83%, from 10% to 45%, from 15% to 78%, from 45% to 83%, from 10% to 15%, from 15% to 45%, from 45% to 78%, or from 78% to 83%.

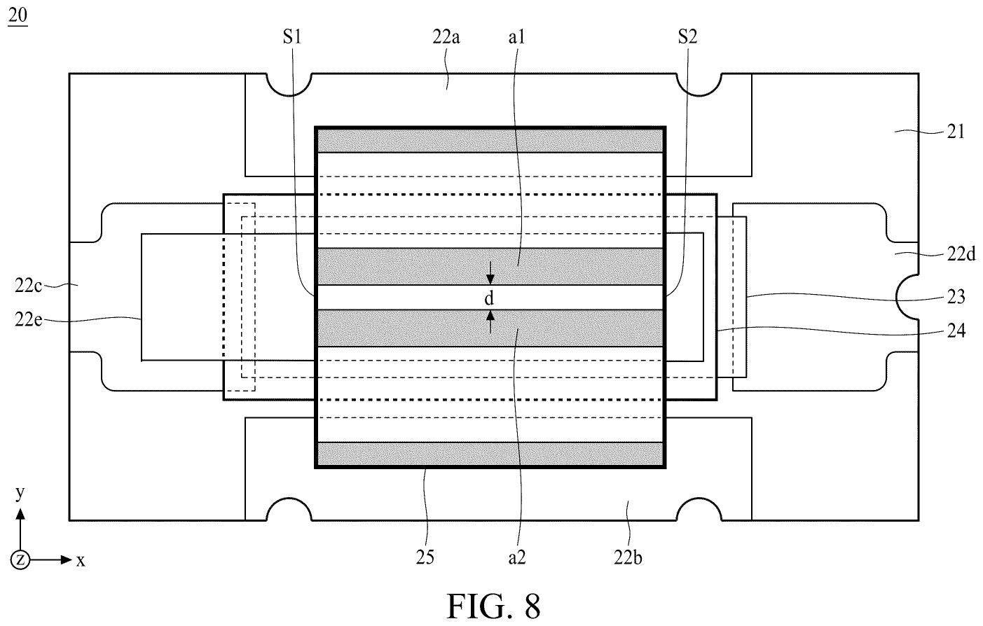

On the auxiliary electrode 22e, the bottom metal layer 25a has a specific covering area. More specifically, in top view, the bottom metal layer 25a on the auxiliary electrode 22e has a second top-view area; and if the sum of the connecting area O and the first top-view area is calculated as 100%, the second top-view area of the bottom metal layer 25a ranges from 50% to 90%. The melting point of the bottom metal layer 25a is lower than the melting point of the core metal layer 25b. The eutectic alloy formed between them can accelerate the blowing action of the core metal layer 25b. However, in order to achieve this technical effect, the second top-view area of the bottom metal layer 25a needs to be controlled within the aforementioned range. If the second top-view area exceeds 90%, an excessive amount of molten metal is produced from the protection device 20 during operation. This may lead to incomplete blowout of the meltable member 25, or increase the risk of reconnection at the break point when it cools down. In addition, the excessive molten metal may flow to any one of electrodes, increasing the risk of short circuit. If the second top-view area is less than 50%, there is an insufficient amount of eutectic alloy formed from them, resulting in poor performance in blowing out the high-melting point metal (i.e., the core metal layer 25b) or even failure to blow out. In one embodiment, depending on the aforementioned range of the connecting area O, the second top-view area may vary from 50% to 80%, 50% to 70%, 50% to 60%, 60% to 90%, 60% to 80%, or 60% to 70%. In another embodiment, the second top-view area may be 50%, 55%, 60%, 65%, 70%, 75%, 80%, 85%, or 90%. The bottom metal layer 25a on the auxiliary electrode 22e may have a square shape, or it can be divided into multiple sections as shown in FIG. 8 to FIG. 10 (which will be described in the following context), with appropriate adjustments made to the covering area.

Please refer to FIG. 5a and FIG. 5b. The hollow part H may penetrate only the core metal layer 25b, or penetrate both the core metal layer 25b and the bottom metal layer 25a. In FIG. 5a, the bottom metal layer 25a directly below the hollow part H entirely covers the auxiliary electrode 22e, so the auxiliary electrode 22e is not exposed through the hollow part H. In FIG. 5b, the bottom metal layer 25a directly below the hollow part H partially covers the auxiliary electrode 22e, thus exposing a part of the auxiliary electrode 22e. In other words, the hollow part H may penetrate the core metal layer 25b and the bottom metal layer 25a, thereby exposing the bottom metal layer 25a and the auxiliary electrode 22e. In FIG. 5b, this design accelerates the temperature increase while reducing the mass to be melted in the middle of the meltable member 25, thereby accelerating the blowing action.

The size of the hollow part H needs to be controlled within a specific range, and the details are described below. In FIG. 3, FIG. 5a, and FIG. 5b, the meltable member 25 extends from the first electrode 22a to the second electrode 22b along a first direction, and has a first length L1 parallel to the first direction and a first width W1 parallel to a second direction. The first direction is substantially parallel to the y-axis, and the second direction is substantially parallel to the x-axis. Therefore, the first direction is perpendicular to the second direction. From the top view, the auxiliary electrode 22e has an electrode width W3 parallel to the first direction, and extends from one side (e.g., the first long side S1 as shown in FIG. 8 to FIG. 10) to the other side (e.g., the second long side S2 opposite to the first long side S1 as shown in FIG. 8 to FIG. 10) of the meltable member 25 along the second direction, by which the meltable member 25 intersects the auxiliary electrode 22e and an overlap region is formed therebetween. The hollow part H is located in the overlap region, and has a second length L2 parallel to the second direction (or the x-axis) and a second width W2 parallel to the first direction (or the y-axis). A ratio of the second length L2 of the hollow part H divided by the first width W1 of the meltable member 25 is less than 0.9, and the second width W2 of the hollow part H is shorter than the electrode width W3 of the auxiliary electrode 22e. If the size of the hollow part H is excessively large, it adversely affects the assembly of the meltable member 25. If the ratio of the second length L2 to the first width W1 is equal to or greater than 0.9, the two lateral sides along the x-axis of the hollow part H become slender and are prone to breakage during the assembly of the meltable member 25 to the substrate 21. If the second width W2 of the hollow part H is equal to or wider than the electrode width W3 of the auxiliary electrode 22e, the structural support along the y-axis (as shown in FIG. 4), which is provided by the auxiliary electrode 22e to bottom of the hollow part H, no longer exists. This also increases the risk of deformation or even breakage. For example, in an embodiment, the first length L1 and the first width W1 of the meltable member 25 are 3.5 mm and 3.5 mm, respectively, and the electrode width W3 of the auxiliary electrode 22e is 1.44 mm. Accordingly, the second length L2 of the hollow part H is preferably less than 3.15 mm, and its second width W2 is preferably less than 1.44 mm. In another embodiment, the first length L1 and the first width W1 of the meltable member 25 may be 4 mm and 3 mm, 5.4 mm and 3.2 mm, or 9.5 mm and 5 mm; and the electrode width W3 of the auxiliary electrode 22e may range from 1 mm to 2 mm. Similarly, the second length L2 and the second width W2 of the hollow part H can be adjusted according to the previous manner.

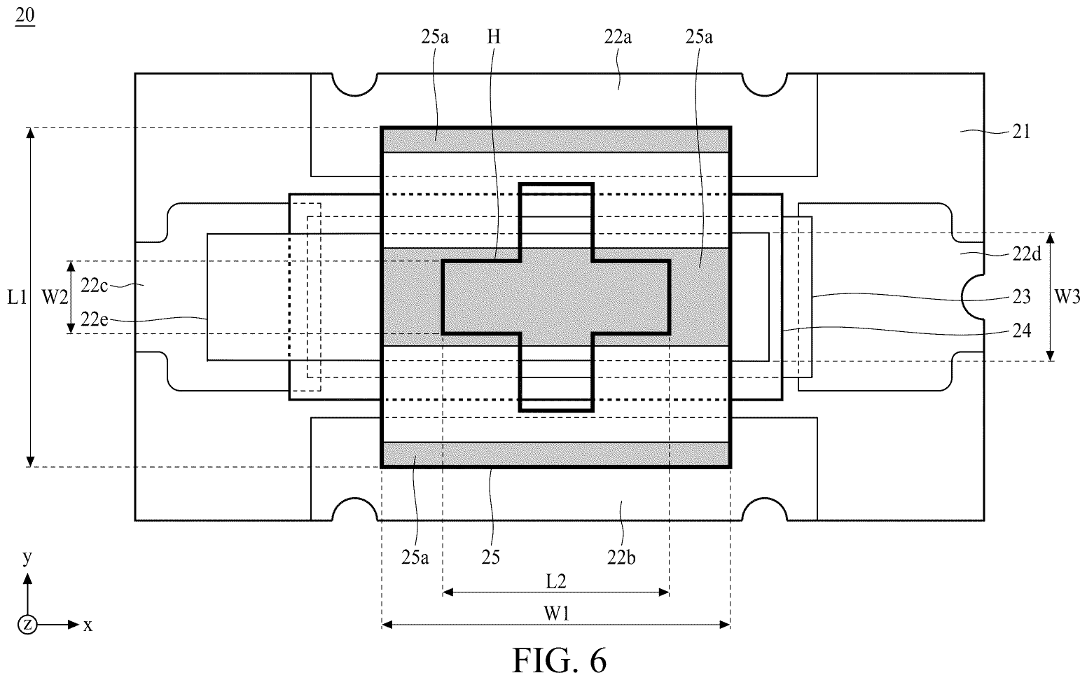

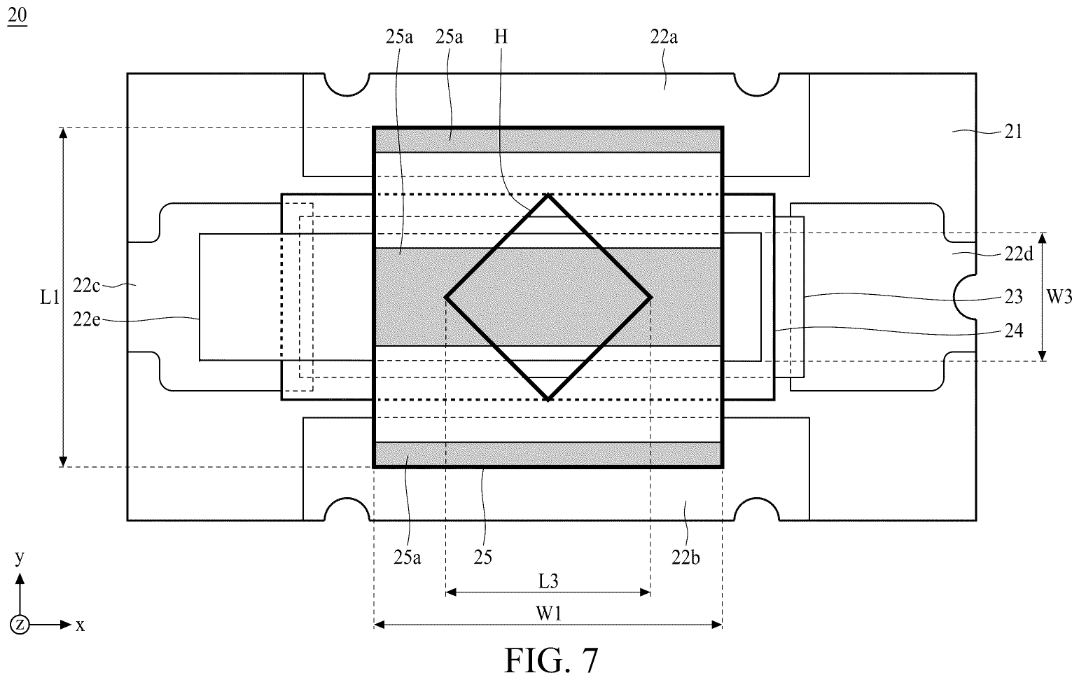

Please refer to FIG. 6 and FIG. 7, in which the hollow part H may have various shapes. The difference between FIG. 3 and FIG. 6/FIG. 7 lies in the shape of the hollow part H. Therefore, the aforementioned connecting area of the core metal layer 25b, the covering area of the bottom metal layer 25a, and other elements can be applied to FIG. 6 and FIG. 7 as well. More specifically, the hollow part H has a square shape, a cross shape, and a diamond shape in FIG. 3, FIG. 6 and FIG. 7, respectively. Additionally, these shapes of the hollow part H should correspond to the specific dimensions, which are detailed below.

In FIG. 6, the hollow part H appears as a cross shape when viewed from the top. It substantially consists of two square recesses (e.g., two hollow parts H shown in FIG. 3) intersecting each other, with one parallel to the x-axis and the other one parallel to the y-axis. Each square recess has the same length and width as the other one. The one parallel to the x-axis has a second length L2 parallel to the aforementioned second direction, and has a second width W2 parallel to the aforementioned first direction. Similarly, a ratio of the second length L2 of the hollow part H divided by the first width W1 of the meltable member 25 is less than 0.9, and the second width W2 of the hollow part H is shorter than the electrode width W3 of the auxiliary electrode 22e. The reasons for these specifications are consistent with those previously mentioned and are not described in detail herein.

In FIG. 7, the hollow part H appears as a diamond shape when viewed from the top. The hollow part H has a diagonal parallel to the x-axis, and the diagonal has a third length L3 similar to the second length L2. Similarly, a ratio of the third length L3 of the hollow part H divided by the first width W1 of the meltable member 25 is less than 0.9. The reason for this is the same as previously mentioned, and is not described herein. In addition, the hollow part H tapers toward its two ends along the y-axis, minimizing the aforementioned issue of structural support.

Please refer to FIG. 8 to FIG. 10, in which the bottom metal layer 25a on the auxiliary electrode 22e may have various configurations. More specifically, the core metal layer 25b of the meltable member 25 is not penetrated, and the distribution of the bottom metal layer 25a can be varied. An overlap region is formed between the core metal layer 25b and the auxiliary electrode 22e in top view, and there is no hollow part H penetrating the core metal layer 25b in the overlap region. The meltable member 25 may exclude the hollow part H. The bottom metal layer 25a on the auxiliary electrode 22e can be divided into a plurality of sections when viewed from the top, and its top-view area is smaller than that of the overlap region. If the top-view area of the overlap region is calculated as 100%, the top-view area of the bottom metal layer 25a on the auxiliary electrode 22e ranges from 30% to 79%. In addition, a shortest distance between any two adjacent sections is at least 0.1 mm. The details are described below.

In FIG. 8, the bottom metal layer 25a is divided into a first section a1 and a second section a2, and the meltable member 25 has a first long side S1 and a second long side S2 opposite to the first long side S1 in top view. The first long side S1 and the second long side S2 are parallel to the y-axis, and extend from the first electrode 22a to the second electrode 22b. Each of the first long side S1 and the second long side S2 has the same length as the aforementioned first length L1 (not shown). The first section a1 and the second section a2 extend from the first long side S1 to the second long side S2, and a shortest distance d between the first section a1 and the second section a2 is at least 0.1 mm. The shortest distance d between any two adjacent sections prevent issues such as failure to blow out or other problems caused by an excessive amount of the bottom metal layer 25a. The shortest distance d enables the sections to form a recess between any two of them on the auxiliary electrode 22e, providing space to accommodate the excessive amount of the bottom metal layer 25a. In this way, during the operation of the protection device 20, the bottom metal layer 25a does not accumulate at the break point, thereby accelerating the blowing action and reducing the possibility of reconnection. Moreover, if the meltable member 25 encounters unexpected high temperatures after its assembly onto the substrate 21, the recess formed by the shortest distance d can also prevent the excessive overflow of the bottom metal layer 25a.

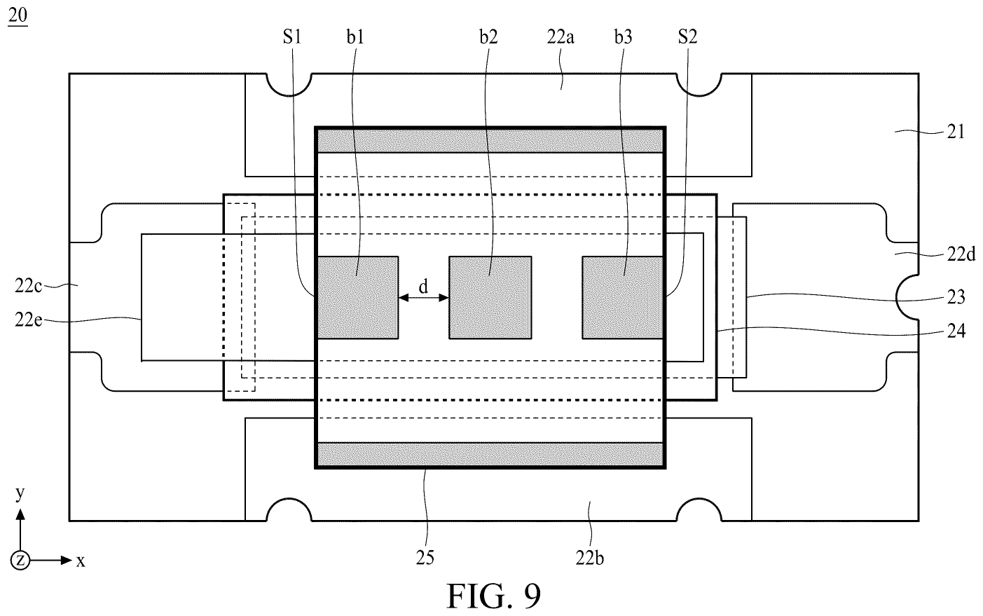

In FIG. 9, the meltable member 25 has the first long side S1 and the second long side S2 opposite to the first long side S1, and the bottom metal layer 25a discontinuously extends from the first long side S1 to the second long side S2 along the x-axis, thereby forming a first section b1, a second section b2, and a third section b3 of the plurality of sections. The first section b1 overlaps the first long side S1, the third section b3 overlaps the second long side S2, and the second section b2 is located between the first section b1 and the third section b3. Similarly, the shortest distance d between any two adjacent sections is at least 0.1 mm.

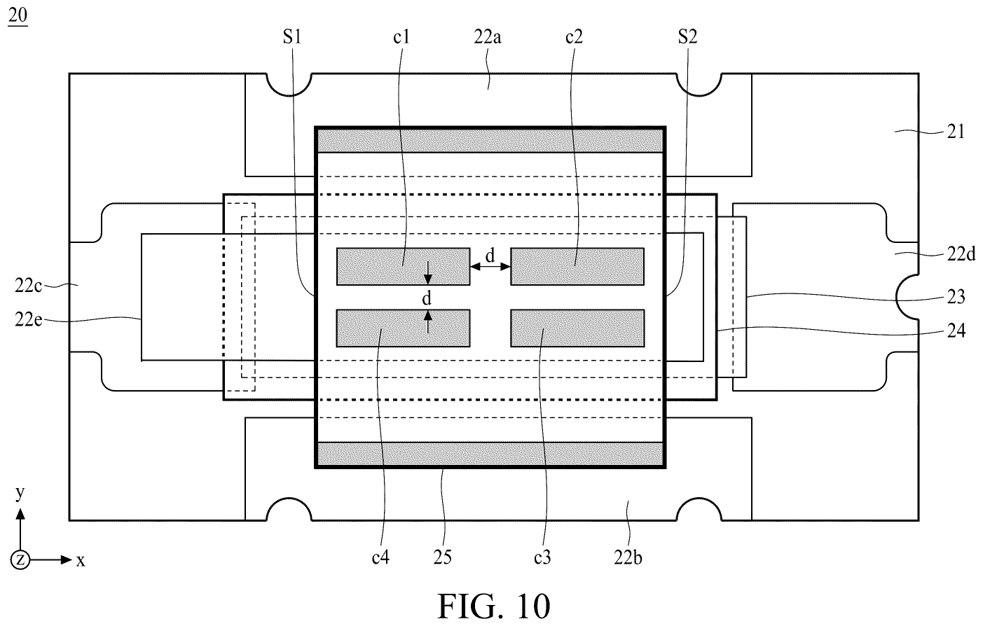

In FIG. 10, the bottom metal layer 25a is divided into a first section c1, a second section c2, a third section c3, and a fourth section c4. The meltable member 25 has the first long side S1 and the second long side S2 opposite to the first long side S1 in top view. These sections (i.e., the first section c1, the second section c2, the third section c3, and the fourth section c4) do not overlap the first long side S1 and the second long side S2, and do not extend to any edge of the auxiliary electrode 22e. Similarly, the shortest distance d between any two adjacent sections is at least 0.1 mm.

Please note that again, the embodiments in FIG. 8 to FIG. 10 may also be applicable to the hollow part H in FIG. 3 to FIG. 7. For example, the bottom metal layer 25a in FIG. 3 can be modified to the bottom metal layer 25a depicted in FIG. 8, FIG. 9, or FIG. 10. The bottom metal layer 25a of FIG. 4 to FIG. 7 may be varied in the same manner. Further details have been previously discussed and are not reiterated herein to avoid redundancy.

In order to describe the connecting area of the core metal layer 25b and the covering area of the bottom metal layer 25a more clearly, the following verification is shown.

TABLE 1

| | | | Covering | | |
|---|---|---|---|---|---|
| | | Connecting | area of | | |
| | | area of core | bottom | Blowout | Blowout |
| | Resistance | metal | metal | time at | acceleration |
| Group | (mΩ) | layer | layer | 43 W(s) | rate |
| C1 | 0.41 | 100% | 80% | 2.68 | — |
| E1 | 0.41 | 78% | 80% | 2.22 | 17.16% |
| E2 | 0.52 | 45% | 80% | 2.1 | 21.64% |
| E3 | 0.68 | 15% | 80% | 2.26 | 15.67% |
| E4 | 0.36 | 100% | 100% | Fail | — |
| E5 | 0.49 | 100% | 78% | 2.505 | 6.53% |
| E6 | 0.56 | 100% | 72% | 1.875 | 30.04% |
| E7 | 0.58 | 100% | 64% | 2.075 | 22.57% |
| E8 | 0.49 | 100% | 52% | 2.155 | 19.59% |
| E9 | 0.46 | 100% | 35% | 2.585 | 3.54% |
| E10 | 0.44 | 100% | 20% | Fail | — |

In Table 1, the test group C1 represents comparative example C1, while the test groups E1 to E10 represent embodiments E1 to E10 of the present invention.

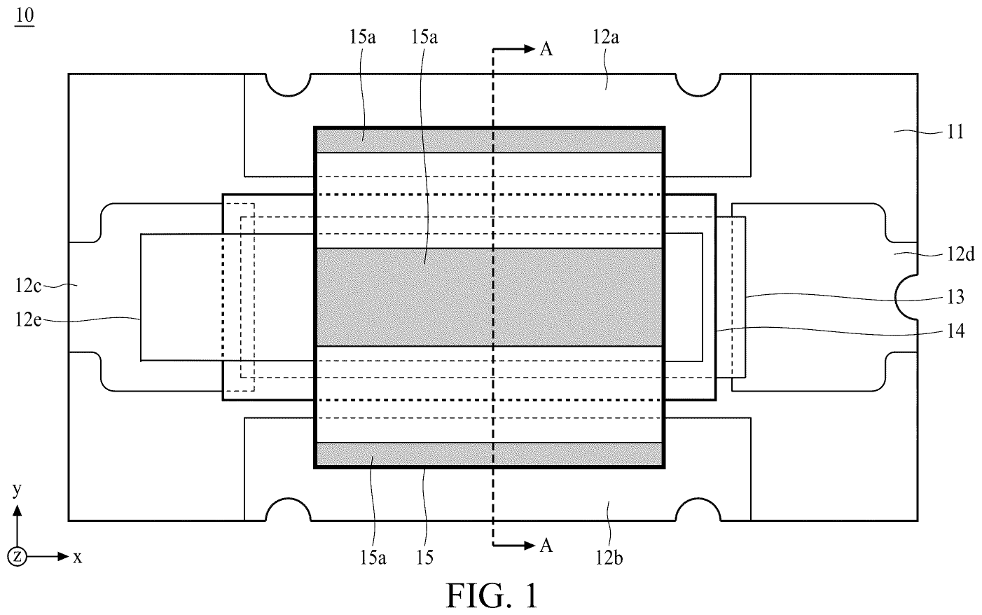

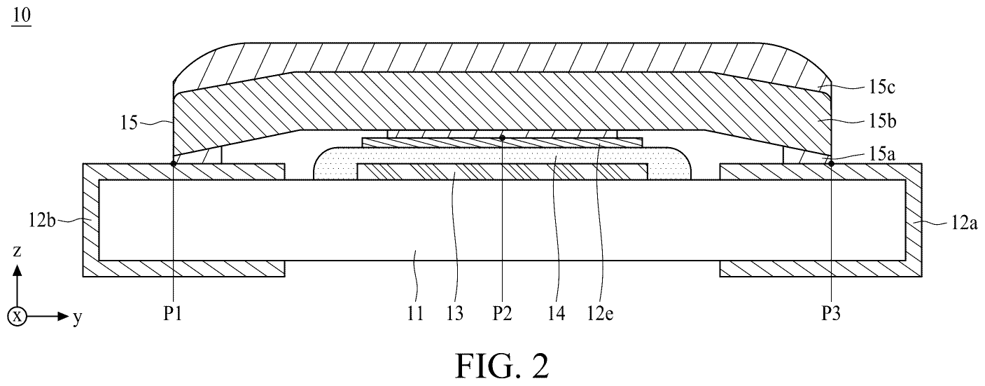

The comparative example C1 corresponds to the protection device 10 in FIG. 1 and FIG. 2. The length and width of the meltable member 15 are 3.5 mm and 3.5 mm. The width of the auxiliary electrode 12e is 1.44 mm. In the meltable member 15, the thickness of the core metal layer 15b is 0.025 mm, and the thickness of the bottom metal layer 15a is 0.2 mm. The meltable member 15 extends along the y-axis, while the auxiliary electrode 12e extends along the x-axis, intersecting with each other to form an overlap region when viewed from the top. The top-view area of the core metal layer 15b on the auxiliary electrode 12e is the same as the top-view area of the overlap region. That is, if the top-view area of the overlap region is calculated as 100%, the connecting area of the core metal layer 15b is 100%. In addition, if the top-view area of the overlap region is calculated as 100%, the covering area of the bottom metal layer 15a on the auxiliary electrode 12e is 80%. The meltable member 15 blows out at 2.68 seconds when the protection device 10 is supplied with a power of 43 watts (W).

The embodiments E1 to E3 correspond to the protection device 20 in FIG. 3 and FIG. 4. The difference between the embodiments E1 to E3 and the comparative example C1 lies in the hollow part H. Additionally, in practical use, the thickness of the core metal layer 25b may vary from 0.01 mm to 0.3 mm, and the thickness of the bottom metal layer 25a may vary from 0.1 mm to 1 mm. The sum of the connecting area O of the core metal layer 25b and the projected area of the hollow part H is equal to the aforementioned top-view area of the overlap region. In the embodiments E1 to E3, if the sum of the connecting area O of the core metal layer 25b and the projected area of the hollow part H is calculated as 100%, the connecting area O of the core metal layer 25b ranges from 15% to 78%. Due to the penetration through the core metal layer 25b, the blowout time of the meltable member 25 is reduced to 2.1 seconds to 2.26 seconds. Compared to the previously mentioned 2.68 seconds, the blowout time is reduced by 15.67% to 21.65%, which can be referred as “blowout acceleration rate” as shown in Table 1. It is noted that when the connecting area O of the core metal layer 25b is significantly less than 15%, an excessive amount of the core metal layer 25b above the auxiliary electrode 22e is removed, making it fragile and easily broken during assembly. Considering the measurement error and the permissible error tolerance, the connecting area O of the core metal layer 25b may vary within the range from 10% to 83%. Due to the presence of the hollow part H, the covering area (i.e., the second top-view area as previously described) of the bottom metal layer 25a may vary within the range from 50% to 90%. Moreover, when adjusting the connecting area O, the dimensions of the hollow part H relative to other components must also be considered to prevent a poor yield rate during assembly.

The embodiments E4 to E10 and the comparative example C1 are devoid of any hollow part H. The difference between them lies in the covering area of the bottom metal layer on the auxiliary electrode. The embodiments E4 to E10 may correspond to the design in FIG. 8 to FIG. 10. In the embodiments E4 to E10, if the top-view area of the overlap region is calculated as 100%, the covering area of the bottom metal layer 25a on the auxiliary electrode 22e ranges from 20% to 100%. As the covering area of the bottom metal layer 25a decreases to the range of 35% to 78%, the blowout acceleration rate ranges from 3.54% to 30.04%. It is noted that if the covering area of the bottom metal layer 25a is excessively large or excessively small, the meltable member 25 fails to blow out. If the covering area of the bottom metal layer 25a is 100%, the auxiliary electrode 22e is entirely covered by the bottom metal layer 25a in the overlap region. This results in an excessive amount of molten metal during operation, leading to failure to blow out. If the covering area of the bottom metal layer 25a is 20%, there is an insufficient amount of eutectic alloy, resulting in failure to blow out the high-melting point metal (i.e., the core metal layer 25b). Considering the measurement error and the permissible error tolerance, the covering area of the bottom metal layer 25a may vary within the range from 30% to 79%.

The above-described embodiments of the present invention are intended to be illustrative only. Numerous alternative embodiments may be devised by persons skilled in the art without departing from the scope of the following claims.

What is claimed is:

1. A protection device, comprising:
a meltable member having a core metal layer and a bottom metal layer disposed below the core metal layer, wherein a melting point of the bottom metal layer is lower than a melting point of the core metal layer;
an electrode set having a first electrode, a second electrode, and an auxiliary electrode, wherein:
two terminals of the meltable member are respectively connected to the first electrode and the second electrode, and the auxiliary electrode is located between the first electrode and the second electrode, and is disposed under the meltable member, thereby contacting the bottom metal layer; and
the meltable member has a hollow part penetrating the core metal layer, whereby the bottom metal layer on the auxiliary electrode is exposed; and
a heating element disposed under the auxiliary electrode, thereby heating up and blowing the meltable member during an over-voltage event.

2. The protection device of claim 1, wherein:
an overlap region between the core metal layer and the auxiliary electrode has a connecting area in top view;
the hollow part has a first top-view area in top view; and
if the sum of the connecting area and the first top-view area is calculated as 100%, the connecting area ranges from 10% to 83%.

3. The protection device of claim 2, wherein the hollow part completely overlaps the auxiliary electrode in top view.

4. The protection device of claim 2, wherein:
the bottom metal layer on the auxiliary electrode has a second top-view area in top view; and
if the sum of the connecting area and the first top-view area is calculated as 100%, the second top-view area ranges from 50% to 90%.

5. The protection device of claim 1, wherein:
the meltable member extends from the first electrode to the second electrode along a first direction, and has a first length parallel to the first direction and a first width parallel to a second direction, wherein the first direction is perpendicular to the second direction;
the auxiliary electrode has an electrode width parallel to the first direction, and extends from one side to the other side of the meltable member along the second direction in top view, whereby the meltable member intersects the auxiliary electrode and an overlap region is formed therebetween;
the hollow part is located in the overlap region, and has a second length parallel to the second direction and a second width parallel to the first direction; and
a ratio of the second length of the hollow part divided by the first width of the meltable member is less than 0.9, and the second width of the hollow part is shorter than the electrode width of the auxiliary electrode.

6. The protection device of claim 1, wherein the hollow part has a square shape, a cross shape, or a diamond shape in top view.

7. The protection device of claim 1, wherein the bottom metal layer on the auxiliary electrode is divided into a plurality of sections in top view.

8. The protection device of claim 7, wherein a shortest distance between any two adjacent sections is at least 0.1 mm.

9. The protection device of claim 1, wherein the core metal layer has a thickness ranging from 0.01 mm to 0.3 mm.

10. The protection device of claim 1, wherein the bottom metal layer has a thickness ranging from 0.1 mm to 1 mm.

11. The protection device of claim 1, wherein the core metal layer consists of a single layer, wherein the core metal layer is made of tin-silver-lead alloy, tin-silver-copper alloy, tin-silver-bismuth alloy, or tin-zinc alloy.

12. The protection device of claim 1, wherein the core metal layer consists of a plurality of metal layers, wherein the core metal layer is a three-layer structure by sequentially stacking a tin layer, a silver layer, and a tin layer, or by sequentially stacking a silver layer, a tin layer, and a silver layer.

13. The protection device of claim 1, wherein the core metal layer consists of a plurality of metal layers, wherein the core metal layer is a five-layer structure by sequentially stacking a silver layer, a tin layer, a silver layer, a tin layer, and a silver layer, or by sequentially stacking a tin layer, a silver layer, a tin layer, a silver layer, and a tin layer.

14. The protection device of claim 1, wherein the bottom metal layer comprises tin, tin-silver-copper alloy, tin-silver-lead alloy, tin-bismuth alloy, or combinations thereof.

15. The protection device of claim 1, wherein the heating element comprises ruthenium oxide, nickel-chromium alloy, lead-germanium alloy, silicon-germanium alloy, or combinations thereof.

16. The protection device of claim 1, further comprising a substrate and an insulating layer, wherein the heating element is disposed on the substrate, and the insulating layer is disposed between the auxiliary electrode and the heating element, and extends to the substrate.

17. The protection device of claim 16, wherein the insulating layer comprises a glass, a glass-ceramic material, aluminum oxide, silicon carbide, magnesium silicon nitride, or combinations thereof.

18. A protection device, comprising:
a meltable member having a core metal layer and a bottom metal layer disposed below the core metal layer, wherein a melting point of the bottom metal layer is lower than a melting point of the core metal layer;
an electrode set having a first electrode, a second electrode, and an auxiliary electrode, wherein:
two terminals of the meltable member are respectively connected to the first electrode and the second electrode, and the auxiliary electrode is located between the first electrode and the second electrode, and is disposed under the meltable member, thereby contacting the bottom metal layer; and
an overlap region is formed between the core metal layer and the auxiliary electrode in top view, and the core metal layer is devoid of any hollow part in the overlap region; and
a top-view area of the bottom metal layer on the auxiliary electrode is smaller than a top-view area of the overlap region; and
a heating element disposed under the auxiliary electrode, thereby heating up and blowing the meltable member during an over-voltage event.

19. The protection device of claim 18, wherein if the top-view area of the overlap region is calculated as 100%, the top-view area of the bottom metal layer on the auxiliary electrode ranges from 30% to 79%.

20. The protection device of claim 18, wherein the bottom metal layer on the auxiliary electrode is divided into a plurality of sections in top view.

21. The protection device of claim 20, wherein the plurality of sections of the bottom metal layer consists of a first section and a second section, and the meltable member has a first long side and a second long side opposite to the first long side in top view, wherein the first section and the second section extend from the first long side to the second long side, and a shortest distance between the first section and the second section is at least 0.1 mm.

22. The protection device of claim 20, wherein the meltable member has a first long side and a second long side opposite to the first long side, and the bottom metal layer discontinuously extends from the first long side to the second long side, thereby forming a first section, a second section, and a third section of the plurality of sections, wherein the first section overlaps the first long side, the third section overlaps the second long side, and the second section is located between the first section and the third section, wherein a shortest distance between any two adjacent sections is at least 0.1 mm.

23. The protection device of claim 20, wherein the plurality of sections of the bottom metal layer consists of a first section, a second section, a third section, and a fourth section, wherein the meltable member has a first long side and a second long side opposite to the first long side in top view, wherein the plurality of sections do not overlap the first long side and the second long side, and the plurality of sections do not extend to any edge of the auxiliary electrode, wherein a shortest distance between any two adjacent sections is at least 0.1 mm.
